(19) United States
(12) Patent Application Publication
(10) Pub. No.: US 2009/0116753 A1
(43) Pub. Date: May 7, 2009

(54) Authenticating and identifying objects using nanoparticles

(75) Inventors: John A. Midgley, San Carlos, CA (US); William M. Pfenninger, Fremont, CA (US); John T. Kenney, Palo Alto, CA (US)

Correspondence Address: COOLEY GODWARD KRONISH LLP;ATTN: Patent Group, Suite 1100, 777 - 6th Street, NW, Washington, DC, 20001, US

(73) Assignee: UltraDots, Inc., Fremont, CA (US)

(21) Appl. No.: 11/518,505

(22) Filed: Sep. 8, 2006

Related U.S. Application Data
(60) Provisional application No. 60/716,656, filed on Sep. 12, 2005.

(51) Int. Cl. G06K 9/68

(52) U.S. Cl. 382/219

(57) ABSTRACT

Apparatus, system, and method to authenticate and identify objects using nanoparticles are described herein. In one embodiment, a computer-readable storage medium includes executable code to: (1) derive an index based on an authentication image of a marking; (2) select a reference image of the marking based on the index; (3) compare the authentication image with the reference image to determine whether the authentication image matches the reference image; and (4) produce an indication of authenticity based on whether the authentication image matches the reference image.

### CROSS-REFERENCE TO RELATED APPLICATION

This application claims the benefit of U.S. Provisional Application Ser. No. 60/716,656, filed on Sep. 12, 2005, the disclosure of which is incorporated herein by reference in its entirety.

### FIELD OF THE INVENTION

The invention relates generally to nanoparticles. More particularly, the invention relates to authenticating and identifying objects using nanoparticles.

### BACKGROUND OF THE INVENTION

An object to be authenticated or identified is sometimes provided with a specific marking, which can be part of the object itself or can be coupled to the object. For example, a commonly used marking is a bar code, which includes a linear array of elements that are either printed directly on an object or on labels that are coupled to the object. These elements typically include bars and spaces, with bars of varying widths representing strings of binary ones, and spaces of varying widths representing strings of binary zeros. While bar codes are useful for tracking locations or identities of objects, these markings can be readily reproduced and, thus, have limited effectiveness in terms of preventing counterfeiting.

It is against this background that a need arose to develop the apparatus, system, and method described herein.

### SUMMARY OF THE INVENTION

In one embodiment, a computer-readable storage medium includes executed code to: (1) derive an index based on an authentication image of a marking; (2) select a reference image of the marking based on the index; (3) compare the authentication image with the reference image to determine whether the authentication image matches the reference image; and (4) produce an indication of authenticity based on whether the authentication image matches the reference image.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a system that can be implemented in accordance with an embodiment of the invention.

FIG. 2 illustrates three different images that can be obtained for three different random arrays of nanoparticles.

### DETAILED DESCRIPTION

### Definitions

The following definitions apply to some of the elements described with regard to some embodiments of the invention. These definitions may likewise be expanded upon herein.

As used herein, the term “set” refers to a collection of one or more elements. Elements of a set can also be referred to as members of the set. Elements of a set can be the same or different. In some instances, elements of a set can share one or more common characteristics.

As used herein, the terms “optional” and “optionally” mean that the subsequently described event or circumstance may or may not occur and that the description includes instances where the event or circumstance occurs and instances in which it does not.

As used herein, the term “ultraviolet range” refers to a range of wavelengths from about 5 nanometer (“nm”) to about 400 nm.

As used herein, the term “visible range” refers to a range of wavelengths from about 400 nm to about 700 mm.

As used herein, the term “infrared range” refers to a range of wavelengths from about 700 nm to about 2 millimeter (“mm”).

As used herein, the term “nanometer range” refers to a range of dimensions from about 0.1 nm to about 10 micrometer (“μm”), such as from about 0.1 nm to about 500 nm, from about 0.1 nm to about 200 nm, from about 0.1 nm to about 100 nm, from about 50 nm to about 100 nm, from about 0.1 nm to about 50 nm, from about 0.1 nm to about 20 nm, or from about 0.1 nm to about 10 nm.

As used herein, the terms “reflection,” “reflect,” and “reflective” refer to a bending or a deflection of light. A bending or a deflection of light can be substantially in a single direction, such as in the case of specular reflection, or can be in multiple directions, such as in the case of diffuse reflection or scattering. In general, light incident upon a material and light reflected from the material can have wavelengths that are the same or different.

As used herein, the terms “luminescence” and “luminescent” refer to an emission of light in response to an energy excitation. Luminescence can occur based on relaxation from excited electronic states of atoms or molecules and can include, for example, chemiluminescence, electroluminescence, photoluminescence, and combinations thereof. For example, in electroluminescence, an excited electronic state can be produced based on an electrical excitation. In photoluminescence, which can include fluorescence and phosphorescence, an excited electronic state can be produced based on a light excitation, such as absorption of light. In general, light incident upon a material and light emitted by the material can have wavelengths that are the same or different. Examples of luminescent materials include intrinsic semiconductors (e.g., indirect band gap semiconductors), intrinsic insulators (e.g., wide band gap semiconductors), intrinsic fluorescent materials (e.g., transition metals and rare earth elements such as lanthanides), and materials doped with an appropriate luminescent material.

As used herein, the term “photoluminescence quantum efficiency” refers to the ratio of the number of photons emitted by a material to the number of photons absorbed by the material.

As used herein, the term “defect” refers to a crystal stacking error, a trap, a vacancy, an insertion, or an impurity.

As used herein, the term “monolayer” refers to a single complete coating of a material with no additional material added beyond the complete coating.

As used herein, the term “nanoparticle” refers to a particle that has at least one dimension in the nanometer range. A nanoparticle can have any of a number of shapes and can be formed from any of a number of materials. In some instances, a nanoparticle includes a “core” formed of a first material, which core can be optionally surrounded by a “shell” formed of a second material or by a “ligand layer.” The first material and the second material can be the same or different. Depending on the configuration of a nanoparticle, the nanoparticle can exhibit size dependent characteristics associated with quantum confinement. However, it is contemplated that a nanoparticle can also substantially lack size dependent characteristics associated with quantum confinement or can exhibit such size dependent characteristics to a low degree. In some instances, a set of nanoparticles can be referred to as being “monodisperse.” When referring to a set of nanoparticles as being monodisperse, it is contemplated that at least about 60% of the set of nanoparticles, such as at least about 75% to about 90%, falls within a specific range of dimensions. For example, a set of monodispersed nanoparticles can deviate less than about 20% root-mean-square (“rms”) in dimension, such as less than about 10% rms in dimension or less than about 5% rms in dimension. In some instances, a set of nanoparticles can be referred to as being “substantially defect free.” When referring to a set of nanoparticles as being substantially defect free, it is contemplated that there is fewer than 1 defect per nanoparticle, such as less than 1 defect per 1000 nanoparticles, less than 1 defect per 10⁶ nanoparticles, or less than 1 defect per 10⁹ nanoparticles. Typically, a smaller number of defects within a nanoparticle translates into an increased photoluminescence quantum efficiency. In some instances, a nanoparticle that is substantially defect free can have a photoluminescence quantum efficiency that is greater than 6 percent, such as at least 10 percent, at least 20 percent, at least 30 percent, at least 40 percent, at least 50 percent. Depending on the configuration of a nanoparticle, the nanoparticle can sometimes have a photoluminescence quantum efficiency that is up to 90 percent (or more). Examples of nanoparticles include quantum dots, quantum wells, and quantum wires.

As used herein, the term “size” refers to a characteristic physical dimension. In the case of a nanoparticle that exhibits size dependent characteristics associated with quantum confinement, a size of the nanoparticle can refer to a quantum-confined physical dimension of the nanoparticle. For example, in the case of a nanoparticle that is substantially spherical, a size of the nanoparticle can correspond to a diameter of the nanoparticle. In the case of a nanoparticle that is substantially rod-shaped with a substantially circular cross-section, a size of the nanoparticle can correspond to a diameter of the cross-section of the nanoparticle. When referring to a set of nanoparticles as being of a particular size, it is contemplated that the set of nanoparticles can have a distribution of sizes around the specified size. Thus, as used herein, a size of a set of nanoparticles can refer to a mode of a distribution of sizes, such as a peak size of the distribution of sizes.

As used herein, the term “quantum dot” refers to a nanoparticle that exhibits size dependent characteristics, such as chemical, magnetic, optical, and electrical characteristics, substantially along three orthogonal dimensions. A quantum dot can have any of a number of shapes, such as spherical, tetrahedral, tripodal, disk-shaped, pyramid-shaped, box-shaped, cube-shaped, and a number of other geometric and non-geometric shapes. A quantum dot that includes a core surrounded by a shell can be referred to as a “core-shell quantum dot.” Examples of quantum dots include nanospheres, nanoellipsoids, nanotetrapods, nanotripods, nanomultipods, and nanoboxes.

As used herein, the term “quantum well” refers to a nanoparticle that exhibits size dependent characteristics, such as chemical, magnetic, optical, and electrical characteristics, substantially along at most a single dimension. An example of a quantum well is a nanoplate.

As used herein, the term “quantum wire” refers to a nanoparticle that exhibits size dependent characteristics, such as chemical, magnetic, optical, and electrical characteristics, substantially along at most two orthogonal dimensions. Examples of quantum wires include nanorods, nanotubes, and nanocolumns.

As used herein, the term “core” refers to an inner portion of a nanoparticle. A core can substantially include a single homogeneous monoatomic or polyatomic material. A core can be crystalline, polycrystalline, or amorphous and can optionally include dopants. A core can be substantially defect free or can include a range of defect densities. While a core sometimes can be referred to as “crystalline” or “substantially crystalline,” it is contemplated that the surface of the core can be polycrystalline or amorphous and that this polycrystalline or amorphous surface can extend a measurable depth within the core to form a “core-surface region.” The potentially non-crystalline nature of the core-surface region does not change what is referred to herein as a substantially crystalline core. The core-surface region can sometimes include defects. In some instances, the core-surface region can range in depth from about one to about five atomic-layers and can be substantially homogeneous, substantially inhomogeneous, or continuously varying as a function of position within the core-surface region.

As used herein, the term “shell” refers to an outer portion of a nanoparticle. A shell can include a layer of a material that covers at least a portion of the surface of a core. An interface region can be optionally positioned between a core and a shell. A shell can substantially include a single homogeneous monoatomic or polyatomic material. A shell can be crystalline, polycrystalline, or amorphous and can optionally include dopants. A shell can be substantially defect free or can include a range of defect densities. In some instances, a material forming a shell has a band gap energy that is larger than that of a material forming a core. In other instances, the material forming the shell can have a band gap energy that is smaller than that of the material forming the core. The material forming the shell can have band offsets with respect to the material forming the core, such that a conduction band of the shell can be higher or lower than that of the core, and a valence band of the shell can be higher or lower than that of the core. The material forming the shell can be optionally selected to have an atomic spacing close to that of the material forming the core. A shell can be “complete,” such that the shell substantially completely covers the surface of a core to, for example, substantially cover all surface atoms of the core. Alternatively, the shell can be “incomplete,” such that the shell partially covers the surface of the core to, for example, partially cover the surface atoms of the core. A shell can have a range of thicknesses, such as from about 0.1 nm to about 100 nm. The thickness of a shell can be defined in terms of the number of monolayers of a material forming the shell. In some instances, a shell can have a thickness from about 0 to about 10 monolayers. A non-integer number of monolayers can correspond to a state in which incomplete monolayers exist. Incomplete monolayers can be homogeneous or inhomogeneous and can form islands or clumps on the surface of a core. A shell can be uniform or nonuniform in thickness. In the case of a shell having nonuniform thickness, it is contemplated that an incomplete shell can include more than one monolayer of a material. A shell can optionally include multiple layers of one or more materials in an onion-like structure, such that each layer acts as a shell for the next-most inner layer. Between each layer there is optionally an interface region.

As used herein, the term “interface region” refers to a boundary between two or more portions of a nanoparticle. For example, an interface region can be positioned between a core and a shell or between two layers of the shell. In some instances, an interface region can exhibit an atomically discrete transition between a material forming one portion of a nanoparticle and a material forming another portion of the nanoparticle. In other instances, the interface region can be an alloy of materials forming two portions of the nanoparticle. An interface region can be lattice-matched or unmatched and can be crystalline, polycrystalline, or amorphous and can optionally include dopants. An interface region can be substantially defect free or can include a range of defect densities. An interface region can be homogeneous or inhomogeneous and can have characteristics that are graded between two portions of a nanoparticle, such as to provide a gradual or continuous transition. Alternatively, the transition can be discontinuous. An interface region can have a range of thicknesses, such as from about 1 to about 5 atomic layers.

As used herein, the term “ligand layer” refers to a set of surface ligands surrounding a core of a nanoparticle. A nanoparticle including a ligand layer can also include a shell. As such, a set of surface ligands of the ligand layer can be bonded, either covalently or non-covalently, to a core, a shell, or both (e.g., in the case of an incomplete shell). A ligand layer can include a single type of surface ligand or a mixture of two or more types of surface ligands. A surface ligand can have an affinity for, or can be bonded selectively to, a core, a shell, or both, at least at one portion of the surface ligand. A surface ligand can be optionally bonded at multiple portions along the surface ligand. A surface ligand can optionally include one or more additional active groups that do not interact specifically with either a core or a shell. A surface ligand can be substantially hydrophilic, substantially hydrophobic, or substantially amphiphilic. Examples of surface ligands include groups such as alkyl groups, alkenyl groups, alkynyl groups, aryl groups, iminyl groups, hydride groups, halo groups, hydroxy groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, thio groups, alkylthio groups, alkenylthio groups, alkynylthio groups, arylthio groups, cyano groups, nitro groups, amino groups, N-substituted amino groups, alkylcarbonylamino groups, N-substituted alkylcarbonylamino groups, alkenylcarbonylamino groups, N-substituted alkenylcarbonylamino groups, alkynylcarbonylamino groups, N-substituted alkynylcarbonylamino groups, arylcarbonylamino groups, N-substituted arylcarbonylamino groups, silyl groups, and siloxy groups. Additional examples of surface ligands include polymers (or monomers for a polymerization reaction), inorganic complexes, molecular tethers, nanoparticles, and extended crystalline structures. A ligand layer can have a range of thicknesses. The thickness of a ligand layer can be defined in terms of the number of monolayers of a set of surface ligands forming the ligand layer. In some instances, a ligand layer has a thickness of a single monolayer or less, such as substantially less than a single monolayer.

### Overview

Embodiments of the invention relate to the use of nanoparticles to form markings for objects. The markings can serve as security markings that are difficult to reproduce and, thus, can be advantageously used in anti-counterfeiting applications. For example, the markings can be used to verify whether objects bearing those markings are authentic or original. Alternatively, or in conjunction, the markings can serve as identification markings and, thus, can be advantageously used in inventory applications. For example, the markings can be used to track identities or locations of objects bearing those markings as part of inventory control.

For some embodiments of the invention, a marking can include multiple elements, including: (1) a spatial pattern; and (2) an array of nanoparticles to encode a set of signatures based on one or more of absorption, scattering, luminescence, and other optical and non-optical characteristics of the nanoparticles. For example, an ink composition can be formed so as to include a set of photoluminescent nanoparticles dispersed therein, and the ink composition can be printed on an object of interest to form a marking thereon. The marking can be formed in a spatial pattern, such as a bar code. While the spatial pattern may be reproduced, the random distribution of the photoluminescent nanoparticles within the marking is difficult or virtually impossible to reproduce. As part of a registration process, a reference image of the marking can be obtained by irradiating the marking, and the reference image can be stored for later comparison. For authentication purposes, an authentication image of the marking can be obtained, and the authentication image can be compared with the reference image. If there is a sufficient match between the images, the object of interest can be deemed to be authentic or original. Advantageously, the spatial pattern can be used to derive an index with respect to which the reference image is stored, and this index can be used to select or target the reference image for subsequent image comparison. In such manner, this index allows rapid matching of images while avoiding the need for a time-consuming search through multiple reference images.

### Security System

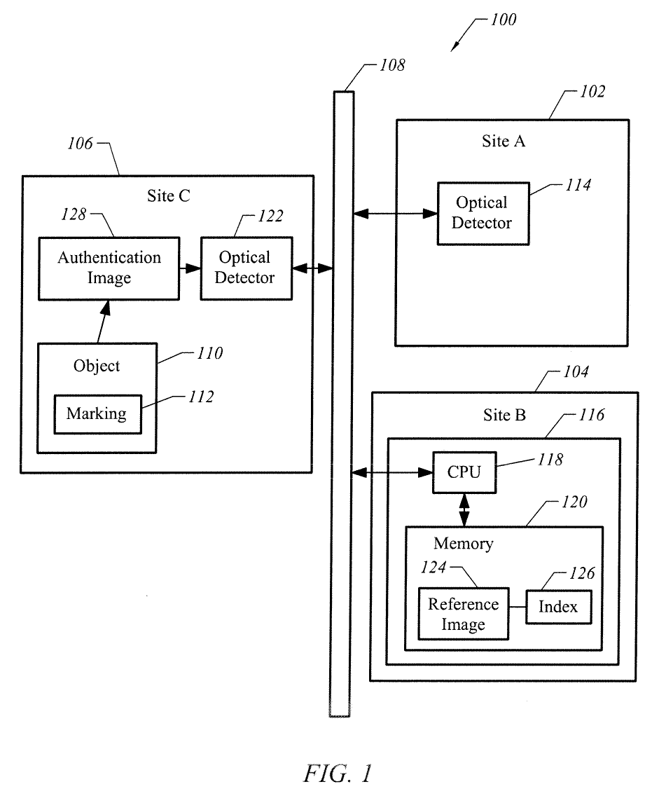

FIG. 1 illustrates a system 100 that can be implemented in accordance with an embodiment of the invention. As further described below, the system 100 can be operated as a security system to prevent or reduce counterfeiting of a variety of objects, such as consumer products, credit cards, identification cards, passports, currency, and so forth.

As illustrated in FIG. 1, the system 100 includes a number of sites, including site A 102, site B 104, and site C 106. Site A 102, site B 104, and site C 106 are connected to a computer network 108 via any wired or wireless communication channel. In the illustrated embodiment, site A 102 is a manufacturing site, a distribution site, or a retail site for an object 110, site B 104 is an authentication and registration site for the object 110, and site C 106 is a site at which a customer is located.

The illustrated embodiment can be further understood with reference to a sequence of operations that can be performed using the system 100. First, at site A 102, a marking 112 is applied to the object 110 (or another object that is coupled to or encloses the object 110). The marking 112 is formed in a spatial pattern, such as a bar code, and includes a random array of nanoparticles that exhibit photoluminescence. As part of a registration process, a reference image 124 of the marking 112 is obtained using an optical detector 114, and the reference image 124 is transmitted to site B 104 along with a request for registration. The reference image 124 includes a representation of the spatial pattern as well as a photoluminescence pattern produced by the random array of nanoparticles. In some instances, multiple reference images of the marking 112 can be obtained using a variety of settings for the optical detector 114.

Second, site B 104 receives the reference image 124 and stores the reference image 124 for later comparison. To allow rapid matching of images, the spatial pattern is used to assign or derive an index 126 with respect to which the reference image 124 is stored. As illustrated in FIG. 1, site B 104 includes a computer 116, which can be a server computer such as a Web server. The computer 116 includes standard computer components, including a central processing unit (“CPU”) 118 that is connected to a memory 120. The memory 120 can include a database within which the reference image 124 is stored. The memory 120 can also include computer code for performing a variety of image processing operations.

Third, at site C 106, the customer may wish to verify whether the object 110 is authentic or original. As part of an authentication process, an authentication image 128 of the marking 112 is obtained using an optical detector 122, and the authentication image 128 is transmitted to site B 104 along with a request for authentication. Similar to the reference image 124, the authentication image 128 includes a representation of the spatial pattern as well as a photoluminescence pattern produced by the random array of nanoparticles. The optical detector 122 can be operated using similar settings used for the optical detector 114 when obtaining the reference image 124. If desired, the authentication image 128 can be at a lower resolution and a greater compression level than the reference image 124. In some instances, global positioning coordinates can be included in the request for authentication, such that the location of the customer or the object 110 can be determined.

Next, site B 104 receives the authentication image 128 and again derives the index 126 based on the spatial pattern. The index 126 is used as a look-up into the memory 120 to select the reference image 124 for comparison with the authentication image 128. If the authentication image 128 sufficiently matches the reference image 124 (e.g., within a specific probability range), site B 104 sends a message to the customer at site C 106 confirming that the object 110 is authentic. In addition to such confirmation, site B 104 can send other information related to the object, such as a manufacturing date, a manufacturing location, an expiration date, and so forth. On the other hand, if the authentication image 128 does not sufficiently match the reference image 124 (or any other reference image), site B 104 sends a message indicating that it is unable to confirm that the object 110 is authentic (or that the object 110 is likely to be a reproduction). Site B 104 can also send authentication information to site A 102, such that the level of counterfeiting can be monitored.

While certain components and operations have been described with reference to specific locations, it is contemplated that these components and operations can be similarly implemented at a variety of other locations. Thus, for example, certain components and operations described with reference to site A 102, site B 104, and site C 106 can be implemented at the same location or at another location that is not illustrated in FIG. 1. Also, while the system 100 has been described with reference to a security system, it is contemplated that the system 100 can also be operated as an inventory system to track identities or locations of a variety of objects as part of inventory control.

### Nanoparticles

A variety of nanoparticles can be used to form markings described herein. Nanoparticles can exhibit absorption, scattering, luminescence, and other optical and non-optical characteristics that can provide a specific signature for authentication and identification purposes. In some instances, optical and non-optical characteristics of nanoparticles can exhibit changes in response to either, or both, electric and magnetic fields. Depending on the configuration of nanoparticles, optical and non-optical characteristics of the nanoparticles can exhibit size dependence associated with quantum confinement. However, it is contemplated that optical and non-optical characteristics of nanoparticles can also substantially lack size dependence. Nanoparticles that are photo-sensitive (e.g., oxidizes when irradiated by light in the ultraviolet range) can be used for read-once or read-sensitive applications.

In the case of scattering, nanoparticles can scatter light in the ultraviolet range, visible range, infrared range, or a combination thereof. The intensity of scattered light can be dependent on a number of factors. For example, a higher scattering intensity can occur for incident light at shorter wavelengths. Also, the intensity of scattered light can depend on a scattering cross-section of the nanoparticles, which, in turn, can depend on a size, shape, and refractive index difference between the nanoparticles and a surrounding material. In some instances, the scattering cross-section can be enhanced by forming the nanoparticles with cores and shells having different refractive indices.

In the case of luminescence, nanoparticles can emit light in the ultraviolet range, visible range, infrared range, or a combination thereof. The intensity of emitted light can be dependent on a number of factors. For example, the intensity as well as the polarization of emitted light can depend on a shape of the nanoparticles. Also, the intensity of emitted light can depend on the intensity of incident light and the mass density per unit area of the nanoparticles. In turn, the mass density per unit area can depend on a size of the nanoparticles and the number of nanoparticles per unit area.

In some instances, it can be desirable to distinguish luminescence and scattering characteristics when detecting an image of a marking. Thus, for example, it can be desirable to obtain a photoluminescence image of the marking while substantially reducing, removing, or filtering out contributions from scattered light. In particular, the marking can include a set of nanoparticles dispersed in a polymer binder or incorporated within a substrate such as paper, and the resulting image may otherwise include contributions from scattering centers corresponding to dirt or from other background scattering (e.g., from the polymer binder or the substrate). Photoluminescence and scattering characteristics can be distinguished based on a number of factors. For example, emitted light and scattered light can exhibit different dependencies on the intensity and wavelength of incident light. In particular, unlike photoluminescent materials, non-photoluminescent materials typically scatter light with an intensity that depends linearly on the intensity of incident light and that scales as the inverse fourth power of the wavelength of incident light. Thus, by appropriately adjusting the intensity and wavelength of incident light, the relative intensity of emitted light and scattered light can be tuned to a desired level. As another example, scattered light can include a first set of wavelengths, while emitted light can include a second set of wavelengths that is different from the first set of wavelengths. In particular, the second set of wavelengths can include longer wavelengths in the case of down-conversion (or shorter wavelengths in the case of up-conversion). Thus, by appropriately exploiting such difference in wavelengths, an image can be obtained primarily from either emitted light or scattered light.

For certain embodiments of the invention, a nanoparticle can include a core formed of a material that exhibits luminescence. The core can have a dimension in the range of about 1 nm to about 100 nm, and the core can be surrounded by a shell having a dimension in the range of about 1 monolayer to about 100 nm.

Materials that can be used to form a core include, for example, oxides (e.g., transition and post-transition metal oxides, wide band gap semiconductor oxides, indirect band gap semiconductor oxides, and any other stable oxides), sulfides, and phosphates. The oxides, sulfides, and phosphates can be doped with transition metals or rare earth elements that exhibit luminescence. Thus, for example, the core can be formed of ZnO doped with Mn, TiO₂ doped with Mn, LaPO₄ doped with Ce or other rare earth element, silicon oxide doped with a transition metal or a rare earth element, or a wide band gap semiconductor oxide doped with a transition metal or a rare earth element. Other examples of materials that can be used to form the core include indirect band gap semiconductors, including Group IV elements such as Si and Ge, and metals, such as noble metals, gold, silver, copper, and other metals that have a plasmon resonance (e.g., absorption edge) in the ultraviolet range, visible range, or infrared range.

Further examples of materials that can be used to form a core include photoluminescent materials having desirable absorption wavelengths (or energies), desirable emission wavelengths (or energies), and desirable photoluminescence quantum efficiencies. Table 1 provides specific examples of materials having these desirable characteristics:

TABLE 1

| Photoluminescent | Absorption | Emission |
|---|---|---|
| material | wavelength | wavelength |
| SrY₂O₄:Eu³⁺ | 250 nm | 611 nm |
| Bi₄Ge₃O₁₂ | 270 nm | 485 nm |
| Gd₃Ga₅O₁₂:Cr³⁺ | 365 nm | 730 nm |
| K₂La₂Ti₃O₁₀:Eu³⁺ | 365 nm | 594 nm |
| K₂La₂Ti₃O₁₀:Eu³⁺ | 365 nm | 617 nm |
| K₂La₂Ti₃O₁₀:Eu³⁺ | 365 nm | 702 nm |
| ZnGa₂O₄ | 250 nm | 460 nm |
| ZnGa₂O₄:Mn²⁺ | 270 nm | 505 nm |
| ZnO:Bi³⁺ | 430 nm | 645 nm |
| ZnO:Ga³⁺ | 250 nm | 388 nm |
| CaO:Zn²⁺ | 250 nm | 370 nm |
| CaO:Eu³⁺ | 410 nm | 600 nm |
| CaO:Tb³⁺ | 420 nm | 560 nm |
| Y₂O₂S:Er³⁺ | 980 nm | 548 nm |
| ZnO:S | 250 nm | 500 nm |
| ZnS:Mn²⁺ | 580 nm | 350 nm |
| ZnS:Eu²⁺ | 540 nm | 400 nm |

Materials that can be used to form a shell include, for example, intrinsic semiconductors, intrinsic insulators, oxides (e.g., silicon oxide, aluminum oxide, titanium oxide, and zirconium oxide), and metals. The shell can provide environmental protection and isolation for a core. The shell can also provide chemical compatibility with a coating or ink composition within which a nanoparticle is dispersed. In some instances, a ligand layer can be used in place of, or in combination with, the shell.

Methods of forming nanoparticles include hydrothermal and chemical precipitation, sintering, and powdering by ball milling or other milling. The resulting nanoparticles can be monodisperse or polydisperse.

### Markings Formed Using Nanoparticles

For some embodiments of the invention, a marking can include multiple elements that can be used for authentication purposes, identification purposes, or both. In some instances, the marking can include the following elements: (1) a spatial pattern; and (2) an array of nanoparticles. Depending on the specific application, the marking can be overt, covert, or a combination thereof. An overt marking is one that is visible, while a covert marking is one that is detected using some type of device.

A. Spatial Pattern

A marking can be formed in a spatial pattern, such as a bar code, a numeric, a logo, or a text. The spatial pattern can provide an initial level of authentication or identification without requiring more advanced image analysis. Thus, for example, the marking can be formed as a bar code and can be simply read by a bar code reader. Also, the spatial pattern can serve as an orientation cue to facilitate proper alignment of the marking with respect to an optical detector when obtaining an image of the marking. Alignment of the marking can be performed manually or using a variety of optical and magnetic imaging methods. It is also contemplated that the spatial pattern can be used for image alignment during storage and matching of images. Advantageously, the spatial pattern can also allow rapid matching of images of the marking. In particular, as part of a registration process, the spatial pattern can be used to derive an index with respect to which a reference image of the marking is stored. Next, as part of an authentication process, the spatial pattern can be used again to derive the index, such that an authentication image of the marking can be directly compared with the reference image, thus avoiding the need for a time-consuming search through multiple reference images.

B. Array of Nanoparticles

A marking can include a set of nanoparticles that provide a set of signatures based on one or more of absorption, scattering, luminescence, and other optical and non-optical characteristics of the nanoparticles. In some instances, the nanoparticles can be distributed in a two- or three-dimensional array and can be incorporated within a spatial pattern, such as a bar code. It is also contemplated that the nanoparticles can be positioned apart from the spatial pattern. As further described below, the nanoparticles can be randomly distributed so as to provide a substantially unique signature.

Nanoparticles used to form a marking can have a single size or multiple sizes. Since optical characteristics of the nanoparticles can be size dependent, the use of multiple sizes can lead to multiple colors (e.g., in a subtractive sense or in an emission sense).

For certain applications, nanoparticles can be randomly distributed in a matrix material, such as within a coating, a film, a slab, or other object. The matrix material is desirably substantially transparent so that emitted or scattered light produced by the nanoparticles can be distinguished in a resulting image. For example, the matrix material can include a polymer, such as polycarbonate, polystyrene, or polyvinyl chloride, or an inorganic glass, such as a silicate, borosilicate, or phosphate. It is contemplated that the matrix material need not be substantially transparent and can include, for example, paper. In the case of a thin film, such as one that is about 10 μm or less in thickness, the nanoparticles can be effectively viewed as a two-dimensional array in a single optical plane. In the case of a thicker film or a self-supporting slab, the nanoparticles can be viewed as a three-dimensional array. In this case, a resulting image of the nanoparticles can depend on a viewing angle of an optical detector. If desired, the nanoparticles can be viewed from multiple directions and angles, resulting in different images.

In some instances, nanoparticles can be incorporated in larger particles, which can have a variety of dimensions and shapes. For example, the nanoparticles can be incorporated in transparent beads having dimensions from about 20 nm to about 1 μm, such that there are multiple nanoparticles in a single bead. The number of nanoparticles per bead can affect the intensity of emitted or scattered light. By incorporating nanoparticles of different sizes or types in a single bead, multiple colors can be incorporated in that bead. The beads including the nanoparticles can be incorporated in a coating, a film, a slab, or other object in a similar fashion as described above. The use of the beads can allow a variation of mixing that typically cannot be achieved with individual nanoparticles.

Nanoparticles used to form a marking can provide multiple signatures that provide multiple levels of security or identification (in addition to an initial level provided by a spatial pattern). Each signature can be used independently of other signatures, and, in some instances, certain signatures can be omitted or skipped for a reduced level of security (but also reduced cost and processing time). It is also contemplated that a signature providing a lower level of security can be used to reduce a search space for another signature providing a higher level of security.

In some instances, multiple signatures can be associated with respective encoding schemes, such as:

(1) Color Encoding

The color of a marking can provide a specific optical signature that can be used for anti-counterfeiting and inventory applications. The color can be detected visually, using an optical detector, or a combination thereof.

As described previously, a marking can be formed from an ink composition, which includes a set of individual nanoparticles or a set of nanoparticles incorporated in larger particles, such as beads. The nanoparticles can have sizes smaller than a quantum confined size so as to exhibit size dependent characteristics associated with quantum confinement. Thus, for example, the absorption spectrum of the nanoparticles can be dependent on the sizes of the nanoparticles. The quantum confined size can be dependent on a material forming the nanoparticles and can range from less than about 1 nm to about 40 nm. If the nanoparticles are larger than the quantum confined size, the absorption spectrum can be intrinsic to the material forming the nanoparticles (e.g., depends primarily on a composition of the material).

In some instances, the color of a marking can be detected visually, and, thus, the marking can serve as an overt security or identification marking. In particular, the marking can be formed of a set of nanoparticles that are colored (e.g., absorb light in the visible range). In such instances, the color of the marking is typically a subtractive or reflective color. In other instances, a marking can be formed of a set of nanoparticles that primarily absorb light in the ultraviolet range, infrared range, or both. As a result, the marking can appear colorless or white and can serve as a covert security or identification marking. In such instances, the color of the marking can be determined with an optical detector that is sensitive to light in the ultraviolet range or infrared range and that includes a pass filter or spectrometer to select light in the ultraviolet range or infrared range.

A marking can also be formed of a set of nanoparticles that exhibit luminescence. Here, incident light and emitted light can have wavelengths that are different. Thus, for example, the nanoparticles can emit light at a longer wavelength, or a lower energy, than incident light. Incident light can be in the ultraviolet range or visible range, while emitted light can be in the ultraviolet range, visible range, or infrared range. In the case of ultraviolet-stimulated nanoparticles, the nanoparticles can absorb little or no light in the visible range, and the marking can appear colorless in a subtractive sense. However, emitted light can be in the visible range, and the marking can appear colored when irradiated. In other instances, the emitted light can be in the ultraviolet range or infrared range, and the marking can remain colorless when irradiated.

Luminescence spectroscopy can be used to determine intensities and wavelengths of emitted light and incident light. In some instances, the operation of luminescence spectroscopy can be dependent on a full width half maximum (“FWHM”) and a Stokes' shift of a set of nanoparticles. The FWHM typically refers to a width of an emission band of the nanoparticles, while the Stokes' shift typically refers to a separation between the emission band and an absorption band of the nanoparticles. A smaller FWHM typically translates into a smaller Stokes' shift that is required to resolve a specific optical signature. For a given FWHM, an incomplete separation between the emission band and the absorption band can sometimes lead to an undesirable level of signal-to-noise ratio due to background noise from incident light. Thus, it can be desirable that the nanoparticles have a large Stokes' shift as well as a high intensity of emitted light. In some instances, luminescence can also be anti-Stokes (e.g., up-conversion), such that the nanoparticles can emit light at a shorter wavelength, or a higher energy, than incident light. Such up-conversion can be exhibited by certain rare earth elements and can give rise to the emission of light in the visible range upon irradiation with light in the infrared range.

(2) Patterning Encoding

Different colors of a marking can also provide a specific optical signature that can be used for anti-counterfeiting and inventory applications. The colors can be detected visually, using an optical detector, or a combination thereof.

As described previously, a marking can be formed in a spatial pattern, such as a bar code. Different portions of the marking can be formed from respective ink compositions having specific colors. Thus, for example, each bar can be formed so as to have a specific color. In such manner, the marking can be formed so as to have a specific pattern of colors. It is also contemplated that each portion of the marking can be formed so as to have another specific characteristic, such as a specific scattering characteristic. The marking can be printed using a standard printing method, such as ink jet printing, offset printing, flexography printing, or intaglio printing. Ink compositions that are used can be dependent on a particular printing method and a particular substrate (e.g., whether the substrate is an absorbent substrate such as paper or a non-absorbent substrate such as a plastic).

(3) Random Encoding

The random positions of a set of nanoparticles can provide a resulting image that includes a substantially unique optical signature, which is similar to a random code. The number of different optical signatures can be dependent on a number of factors, such as the number of discrete scattering or luminescent centers and resolutions of an optical detector, a communication channel, and a memory. Since the number of discrete scattering or luminescent centers can be relatively large (e.g., greater than about 1000), the number of different optical signatures is sufficiently large (e.g., greater than about 10³⁰) to render reproduction difficult or virtually impossible. In some instances, an image can be divided into a grid with a number of grid positions. Each grid position can either have or not have a nanoparticle positioned at or near that grid position. The number of grid positions (e.g., size of the grid) can correspond to a spatial resolution of an optical detector. For example, each grid position can correspond to a certain number of pixels, such as 10 pixels. Thus, a 1 mega-pixel camera with 10⁶ pixels would produce a grid with 10⁵ grid positions. For this example, up to 2^{100,000} or approximately 10^{30,000} different optical signatures can be produced. As another example, the number of different optical signatures can be greater than 10¹⁰⁰ for a grid of 10² μm². Since the position of a nanoparticle can vary substantially continuously for both X and Y directions along a grid, the spatial resolution of an optical detector typically restricts or sets an upper bound on the number of different optical signatures. However, it is contemplated that sub-pixel resolution methods can be used to increase the number of different optical signatures. It is also contemplated that the number of different optical signatures can be increased by detecting multiple optical characteristics (e.g., absorption, scattering, and luminescence), in which case the number of different optical signatures can correspond to the number of optical characteristics multiplied by the spatial resolution of the optical detector.

In the case of photoluminescence, emitted light can be dependent on the intensity and wavelength of incident light, and an optical signature can be coded with respect to either of, or both, the intensity and wavelength of incident light. A marking can sometimes become degraded by dirt, surface scratches, and other damage. However, an optical signature can nevertheless be detected since dirt and surface scratches typically have different intensity and wavelength response than a set of photoluminescent nanoparticles. Multiple intensities and wavelengths of incident light can facilitate the detection of the optical signature. In some instances, a resulting image can include different intensity levels from a set of nanoparticles. In such instances, the image can be multi-level in intensity, rather than simply binary with respect to the presence or absence of a nanoparticle at each grid position. As described previously, nanoparticles can be incorporated in larger particles, which can serve as pigments in an ink composition or as carriers in a coating composition. In such manner, different intensity levels can be achieved by varying the concentration or the number of nanoparticles within the larger particles.

In the case of electroluminescence, emitted light can be dependent on the strength of an applied electric field, and an optical signature can be coded with respect to that strength. In addition, the intensity and wavelength of emitted light can be dependent on the composition of an ink composition that is used to form a marking. The ink composition can include a set of electroluminescent nanoparticles dispersed in a conductive binder. When forming the marking, an electrically conductive material can be initially deposited on a substrate to form a first conductive layer. Next, the ink composition can be deposited on the first conductive layer to form the marking, and the same or a different electrically conductive material can be deposited on the marking to form a second conductive layer. In such manner, the marking can bridge a planar gap between the two conductive layers. The two conductive layers can then be connected to an electrical source, and, as an electric current flows though the marking, the nanoparticles within the marking can emit light.

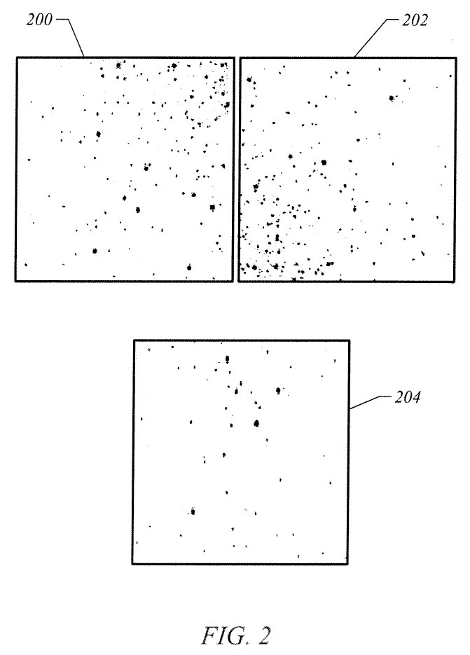

FIG. 2 illustrates three different images 200, 202, and 204 that can be obtained for three different random arrays of nanoparticles. As illustrated in FIG. 2, the random positions of nanoparticles within each array can provide a photoluminescence pattern that is substantially unique.

(4) Spectral Encoding

A marking can be formed of a mixture of nanoparticles that have different absorption and emission spectra. The different absorption and emission spectra can also provide a specific optical signature for anti-counterfeiting and inventory applications. The specific optical signature can be detected using luminescence spectroscopy.

(5) Polarization Encoding

Depending on specific characteristics of a set of nanoparticles forming a marking, the marking can exhibit birefringence and, thus, can be sensitive to the polarization of incident light, emitted light, or both. This polarization sensitivity can also provide a specific optical signature for anti-counterfeiting and inventory applications. Nanoparticles used in polarization encoding can have aspect ratios greater than 1, such as nanorods or nanoellipsoids, and can be aligned in a preferential direction, such as using flow induced alignment. As can be appreciated, polarization typically refers to the direction of an electric field component of light. The direction of the electric field component can be perpendicular to a propagation direction of light in the case of linear polarization but can also be rotating in the case of circular polarization. The degree of polarization can be determined using an optical detector and a rotatable linear polarizer. If light is unpolarized, the intensity at the optical detector is typically not affected by rotation of the linear polarizer. However, if light is polarized, rotation of the linear polarizer can change the intensity at the optical detector from 0% to 100% as the linear polarizer rotates from an orientation perpendicular to the polarization of light to an orientation parallel to the polarization of light.

In some instances, the relationship between polarization and intensity can be expressed by the following equation: P=(Iₚₐᵣₐₗₗₑₗ−I_{perpendicular})/(Iₚₐᵣₐₗₗₑₗ+I_{perpendiular}). Here, Iₚₐᵣₐₗₗₑₗ is the intensity of emitted light having a polarization parallel to a polarization of incident light (or parallel to the alignment of a set of nanoparticles), and I_{perpendicular} is the intensity of emitted light having a polarization perpendicular to the polarization of incident light (or perpendicular to the alignment of the nanoparticles). P is the degree of polarization and can vary from 0 to ½ for randomly aligned nanoparticles and from 0 to 1 for nanoparticles aligned in a preferential direction.

In the case of randomly aligned nanoparticles (or those having aspect ratios around 1), there is typically little or no polarization sensitivity for incident light and emitted light. In the case of nanoparticles aligned in a preferential direction, the intensity of absorption can depend on the polarization of incident light. Incident light with a polarization parallel to an alignment direction of the nanoparticles can be absorbed more strongly than incident light with a polarization perpendicular to that alignment direction. As a result of the larger intensity of absorption, the intensity of emitted light can also be greater for incident light with a polarization parallel to that alignment direction. As the aspect ratio of the nanoparticles increases (e.g., as their shape goes from spherical to a disc to a rod), the degree of polarization sensitivity increases.

(6) Magnetic Encoding

Depending on specific characteristics of a set of nanoparticles forming a marking, the marking can also exhibit ferromagnetism. Nanoparticles used in magnetic encoding can have aspect ratios greater than 1 and can be aligned in a preferential direction. In addition, the nanoparticles can be ferromagnetic. Examples of ferromagnetic nanoparticles include those formed of ZnO doped with Mn and those formed of other ferromagnetic materials. These ferromagnetic nanoparticles can be incorporated in larger particles, such as beads. It is also contemplated that non-ferromagnetic nanoparticles can be combined with a ferromagnetic material to form a composite particle, such as a composite bead.

(7) Other Types of Encoding

The absorption and emission spectra of a set of nanoparticles can be modified by magnetic and electric fields. These fields can be used to provide other types encoding schemes for anti-counterfeiting and inventory applications:

(i) Zeeman Effect Encoding: Energy levels of atoms or molecules can be separated by applying a magnetic field. For example, a nanoparticle formed of an oxide doped with Eu or formed of a doped phosphate can exhibit luminescence at a wavelength of about 20 nm when a magnetic field of about 1 Tessla is applied.

(ii) Stark Effect Encoding: Energy levels of atoms or molecules can be separated by applying an electric field. For example, a nanoparticle formed of an oxide doped with Eu or formed of a doped phosphate can exhibit luminescence at a wavelength of about 10 nm when an electric field of about 10 V/μm is applied.

As a specific example, a marking can provide three levels of security or identification. An initial level can be provided by a bar code or a numeric, which can be read visually or using an optical detector. A second level can be provided by a color of the marking. Next, a third and highest level can be provided by a substantially unique optical signature that is based on the random distribution of a set of nanoparticles (e.g., in two- or three-dimensions) and a set of optical and non-optical characteristics of the nanoparticles.

### Formation of Markings

A variety of methods can be used to form markings described herein. In some instances, a coating, ink, or varnish composition can be formed so as to include a set of nanoparticles dispersed therein. The composition can include the nanoparticles as a pigment component along with one or more of the following: a solvent, a wetting agent (e.g., a surfactant), a polymer binder (or other vehicle), an anti-foaming agent, a preservative, and a pH adjusting agent. Next, a coating or printing method can be used to deposit the composition on an object of interest (or another object that is coupled to or encloses the object of interest), which serves as a substrate. Thus, for example, a marking can be formed using a standard coating method, such as roller coating or spray coating, or using a standard printing method, such as screen printing, ink jet printing, offset printing, gravure printing, flexography printing, intaglio printing, or screen printing. Using a standard coating or printing method, the nanoparticles can be deposited as a random array within a spatial pattern, which allows alignment and matching of images.

To achieve higher levels of security, a coating, ink, or varnish composition can include a set of inert masking agents that provide a mixed compositional signature when using chemical analytical methods. Also, the composition can include a relatively low concentration of nanoparticles (e.g., a few micrograms per marking), thus rendering chemical analysis difficult. Moreover, size dependent characteristics of the nanoparticles can provide a set of signatures that cannot be readily reproduced by the same composition of matter in bulk form.

In other instances, a marking can be formed by incorporating a set of nanoparticles within an object of interest (or another object that is coupled to or encloses the object of interest). Thus, for example, the nanoparticles can be incorporated during formation of the object of interest, rather than deposited afterwards. In particular, a matrix material including the nanoparticles can be cast into a film, a slab, or any other shape.

### Optical Detectors

A variety of optical detectors can be used to detect markings described herein. As described previously, a marking can provide multiple levels of security or identification, and an optical detector can detect all levels or a limited set of levels for simplicity and reduced cost.

In some instances, an optical detector includes a light source and a reader that is coupled to the light source. To facilitate registration of objects as well as subsequent authentication and identification of those objects, a portable computing device can be used as an optical detector. Examples of portable computing devices include laptop computers, palm-sized computers, tablet computers, personal digital assistants, cameras, and cellular telephones.

A. Light Source

Depending on specific characteristics of a marking, a light source can produce incident light having a set of wavelengths in the ultraviolet range, visible range, infrared range, or a combination thereof. For the detection of a photoluminescence image, a wavelength of incident light can be matched with an absorption band of a set of nanoparticles. For a mixture of nanoparticles, incident light can have multiple wavelengths that are matched to different absorption bands. The use of multiple wavelengths can allow a set of different photoluminescence images to be produced based on those wavelengths. For the detection of a scattering image, the intensity of scattered light can be dependent on a number of factors, such as a wavelength of incident light, a scattering cross-section of a set of nanoparticles, and a composition of the nanoparticles (e.g., a composition of cores and shells forming the nanoparticles). The uniformity of incident light can affect relative intensity of emitted light and scattered light for different regions of the marking. Polarization of incident light can be an important factor for the detection of an image produced based on anisotropic or irregularly shaped nanoparticles. In addition, incident light can be collimated (or quasi-collimated), such as produced by a laser or focused by a lens, and the degree of collimation can affect luminescence and scattering characteristics of a set of nanoparticles, particularly anisotropic nanoparticles. In some instances, the intensity of incident light can be modulated (e.g., frequency modulated with a continuous or varying frequency), and such intensity modulation can be advantageously used as part of an encoding scheme, as part of image detection, or both.

Examples of light sources include incandescent light sources, light emitting diodes, lasers, sunlight, and ambient light sources. Photoluminescent and scattering characteristics of a set of nanoparticles can depend on the spectrum of a light source. In particular, ambient and incandescent light sources often have continuous spectral outputs over an extended range of wavelengths, while light emitting diodes and lasers have spectral outputs over a shorter range of wavelengths. In some instances, a laser can be desirable, since it provides coherent light that can be used for phase sensitive detection, such as using a speckle pattern. In other instances, a color video monitor, a computer monitor screen, or other color display screen, such as of a cellular telephone phone, can be used as a light source over a relatively narrow range of wavelengths, typically about 100 nm full width half maximum. In yet other instances, a flash unit, such as of a camera or a cellular telephone phone equipped with a camera, can be used as a light source.

B. Reader

A reader can include an imager, such as a multi-dimensional imager, and an optical unit that is positioned between the imager and a marking. The relative orientation (e.g., angle and distance) of the reader with respect to the marking and a light source can be fixed or can be determined during reading, that is, by irradiating the marking and detecting characteristics of an image obtained from the marking. In some instances, the relative orientation of the reader with respect to the light source can affect the relative intensity of emitted light and scattered light and can be encoded for matching of images. Also, the spatial resolution, spectral resolution, and field size of the reader can affect the number of possible resolvable optical signatures in a resulting image. In addition, the spectral response of the reader can affect the range and number of possible colors that can be resolved, such as for fixed linewidth nanoparticles.

In some instances, an imager can include a charge-coupled device, such as one included in a digital camera. The digital camera can be used to record an image for digital storage. The digital camera can be connected to a computer network or can be used to store the image in a local storage device, such as a flash stick, for later downloading to the computer network. For example, the digital camera can be part of a cellular telephone, which can provide wireless transmission of the image to the computer network.

An optical unit can include a set of optical elements, such as lenses, apertures, filters, polarizers, and combinations thereof. In the case of a depth-resolvable encoding scheme, such as for a marking incorporated within a thick film or a slab, the optical unit can be used to determine a three-dimensional resolution of the marking. In the case of a laser that provides coherent light, phase sensitive detection can be used for an enhanced level of security. In this case, the optical unit can include a split optical path. Other types of optical elements can be used to select optical characteristics of interest, such as a specific set of wavelengths, a specific polarization, or a specific range of intensities. In some instances, a filter can be used to remove contributions from a light source. The filter can be a short wavelength cutoff filter, a long wavelength cutoff filter, or a notch filter. For example, a short wavelength cutoff filter can be used to remove wavelengths below 550 nm.

### Image Processing

A variety of methods can be used for converting a raw image of a marking into a format (e.g., a digital format) suitable for transmission and storage. In particular, a variety of image transformation methods, such as Fourier-based methods and wavelet-based methods, and a variety of image compression methods, such as those associated with Moving Picture Experts Group (“MPEG”) or Joint Photographic Experts Group (“JPEG”), can be used for the transmission and storage of images. In some instances, an image can be divided into a grid with a number of grid positions. Each grid position can be associated with an intensity value of emitted or scattered light. This position and intensity information can be further associated with, for example, polarization information, spectral information, depths, angle of irradiation or detection, phase information, and other information that is encoded by the marking. To facilitate subsequent matching of images, the set of information derived from the raw image can be stored in a database, such as a relational database. In particular, the set of information can be stored with respect to an index derived from a bar code or other spatial pattern associated with the marking.

A variety of methods can be used for comparing images of a marking to determine whether there is a sufficient match. As described previously, the marking can encode information at multiple levels of security or identification, and comparison of images can be performed at all levels or a limited set of levels for simplicity and reduced cost.

It should be recognized that the embodiments of the invention described above are provided by way of example, and various other embodiments and advantages are provided by the invention.

For example, referring to FIG. 1, it is contemplated that site B 104 can send other information to the customer, including marketing and advertising information such as: (1) sales or special promotions; (2) complimentary products from the same or a different manufacturer; (3) other products of potential interest to the customer; and (4) web sites of potential interest to the customer. By operating in the above-described manner, site B 104 can provide the following benefits: (1) customers can verify that they are purchasing authentic products; (2) customers can purchase other related products; (3) the ability to verify authenticity of a product can provide product differentiation; (4) a manufacturer can determine whether inventory at a retail store is authentic; (5) a manufacturer can track product interest by the number of requests for authentication (even if there is no actual purchase); and (6) a manufacturer can track a purchased product based on global positioning coordinates or other information (e.g., a cellular telephone number). In some instances, site B 104 can derive revenue based on one or more of the following: (1) the marking 112 (or a ink composition used to form the marking 112); (2) storage of images; (3) facilitating access to a manufacturer; (4) confirming whether a product is authentic; (5) advertising related to a product; and (6) facilitating access to other web sites.

As another example, a marking can include both overt and covert elements to provide multiple levels of security. An initial reference image can represent both the overt and covert elements of the marking. For a lower level of security, a subsequent authentication image can be at a lower resolution and can include a smaller image area. Also, the authentication image can simply represent the overt element of the marking. For a higher level of security, the authentication image can be at a higher resolution and can also represent the covert element of the marking. For example, the marking can be formed of both visible (e.g., colored) nanoparticles and colorless nanoparticles. In particular, one set of nanoparticles can appear colored, while another set of nanoparticles can appear colorless in the absence of irradiation but can appear colored upon irradiation. Possible combinations of absorption/emission characteristics of a set of nanoparticles include: ultraviolet range/ultraviolet range, ultraviolet range/visible range, ultraviolet range/infrared range, visible range/visible range, visible range/infrared range, and infrared range/visible range (e.g., via up-conversion).

As another example, multi-spectral imaging can be used to obtain a sequence of color images of a marking at multiple wavelengths. The color images can be based on absorption of light, emission of light, or both, and the resulting colors can be in a subtractive sense, emission sense, or both. For example, the marking can be formed of four sets of nanoparticles having the following absorption/emission characteristics: 250 nm/611 nm, 365 nm/730 nm, 410 nm/600 nm, and 430 nm/645 nm. In particular, the four sets of nanoparticles can be formed of the following materials: SrY₂O₄:Eu³⁺, Gd₃Ga₅O₁₂:Cr³⁺, CaO:Eu³⁺, and ZnO:Bi³⁺. Distinct light sources can be used for different wavelengths. Examples of light sources include discharge lamps (e.g., mercury lamps) that emit light at 254 nm and 365 nm and light emitting diodes and laser diodes that emit light in the range of 360 nm to 980 nm. The same reader can be used for all wavelengths. The color images can be obtained in one of two methods. In one method, wavelength separation can occur between the marking and the reader while the marking is irradiated with multiple wavelengths at once. This method can involve the use of a set of filters, which can be used one at a time to obtain the color images. In another method, the marking is sequentially irradiated with different wavelengths, and the reader obtains the color images in sequence. This method allows the reader to be simpler and does not require moving parts.

As a further example, a marking can be formed of nanoparticles so that a resulting image of the marking can be difficult to reproduce via a standard printing method, such as ink jet printing. In particular, the resulting image can have characteristics (e.g., covert characteristics) that are difficult to reproduce using standard ink compositions used for ink jet printing. Moreover, the nanoparticles can be selected so as to be not readily dispersed in standard binders, thus rendering reproduction via ink jet printing even more difficult. For example, the marking can be formed of multiple sets of nanoparticles having different absorption/emission characteristics. The nanoparticles can be incorporated in larger particles, such as beads, such that there are different nanoparticles incorporated in the same larger particle. By proper selection of the nanoparticles, proper formulation of an ink composition to duplicate the resulting image can be difficult. In particular, formulation of an ink composition typically requires dispersion of pigments in a binder, rather than aggregation of those pigments. Thus, by incorporating different nanoparticles in the larger particles, the nanoparticles can be effectively aggregated in a manner that is difficult to reproduce.

Certain embodiments of the invention relate to a computer storage product with a computer-readable medium including data structures and computer code for performing a set of computer-implemented operations. The medium and computer code can be those specially designed and constructed for the purposes of the invention, or they can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remote computer to a requesting computer by way of data signals embodied in a carrier wave or other propagation medium via a transmission channel. Accordingly, as used herein, a carrier wave can be regarded as a computer-readable medium. Another embodiment of the invention can be implemented in hardwired circuitry in place of, or in combination with, computer code.

A practitioner of ordinary skill in the art requires no additional explanation in developing the embodiments described herein but may nevertheless find some helpful guidance by examining the patent of Lee et al., U.S. Pat. No. 6,819,845, entitled “Optical Devices with Engineered Nonlinear Nanocomposite Materials” and issued on Nov. 16, 2004; the patent of Lee et al., U.S. Pat. No. 6,794,265, entitled “Methods of Forming Quantum Dots of Group IV Semiconductor Materials” and issued on Sep. 21, 2004; the patent of Lee et al., U.S. Pat. No. 6,710,366, entitled “Nanocomposite Materials with Engineered Properties” and issued on Mar. 23, 2004; and the patent of Lee, U.S. Pat. No. 7,005,669, entitled “Quantum Dots, Nanocomposite Materials with Quantum Dots, Devices with Quantum Dots, and Related Fabrication Methods” and issued on Feb. 28, 2006; the disclosures of which are incorporated herein by reference in their entireties. A practitioner of ordinary skill in the art may also find some helpful guidance by examining the patent application of Lee, U.S. patent application Ser. No. 10/212,001 (U.S. Patent Application Publication No. 2003/0066998), entitled “Quantum Dots of Group IV Semiconductor Materials” and filed on Aug. 2, 2002; the disclosure of which is incorporated herein by reference in its entirety.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A computer-readable storage medium comprising executable code to:
derive an index based on an authentication image of a marking;
select a reference image on the marking based on the index;
compare the authentication image with the reference image to determine whether the authentication image matches the reference image; and
produce an indication of authenticity based on whether the authentication image matches the reference image.

2. The computer-readable storage medium of claim 1, wherein the authentication image includes a representation of a spatial pattern included in the marking, and the executable code to derive the index includes executable code to derive the index based on the representation of the spatial pattern.

3. The computer-readable storage medium of claim 2, wherein the spatial pattern corresponds to at least one of a bar code, a numeric, a logo, and a text.

4. The computer-readable storage medium of claim 1, further comprising executable code to:
derive the index based on the reference image; and
store the reference image with respect to the index.

5. The computer-readable storage medium of claim 1, wherein the authentication image includes a first representation of an array of nanoparticles included in the marking, the reference image includes a second representation of the array of nanoparticles, aid the executable code to compare the authentication image with the reference image includes executable code to compare the first representation with the second representation.

6. The computer-readable storage medium of claim 5, wherein the first representation corresponds to a first photoluminescence pattern produced by the array of nanoparticles, and the second representation corresponds to a second photoluminescence pattern produced by the array of nanoparticles.
